(19) United States
(12) Patent Application Publication
(10) Pub. No.: US 2025/0136132 A1
(43) Pub. Date: May 1, 2025

(54) Essential Information Prioritizing Display

(71) Applicant: Nissan North America, Inc., Franklin, TN (US)

(72) Inventors: Takehito Teraguchi, Cupertino, CA (US); Stefan Witwicki, San Carlos, CA (US); Erik St. Gray, Tacoma, WA (US)

(21) Appl. No.: 18/385,815

(22) Filed: Oct. 31, 2023

(51) Int. Cl. B60W 50/14; B60W 40/04; B60W 40/08; G01C 21/00

(52) U.S. Cl. CPC B60W 50/14; B60W 40/04; B60W 40/08; G01C 21/3848; B60W 2040/0818; B60W 2050/146; B60W 2540/229; B60W 2556/10; B60W 2556/40; B60W 2556/50

(57) ABSTRACT

Prioritizing essential information for display within a vehicle notification system includes detecting a change in a traffic scene. The traffic scene encompasses a portion of a vehicle transportation network. In response to detecting the change in the traffic scene, it is determined that the traffic scene requires more than a defined level of operator engagement. In response to determining that the traffic scene requires more than the defined level of operator engagement, the traffic scene is stored to a traffic scene storage location. Further, it is determined that an operator is not aware of the traffic scene. Responsive to determining that the operator is not aware of the traffic scene, a control system of a vehicle notifies the operator that the traffic scene requires more than the defined level of operator engagement.

### TECHNICAL FIELD

This application relates to a vehicle control system. More specifically, the application relates to prioritizing essential information for display within a vehicle notification system for vehicle control.

### BACKGROUND

Increasing sensor usage within vehicles create the potential for more information being displayed to an operator. However, displaying an excessive amount of information to an operator may lead to less information being acknowledged by the operator. Limiting the amount of information to only the most important information allows for more efficient communication of dangerous or potentially life-threatening situations to the operator.

### SUMMARY

Disclosed herein are aspects, features, elements, and implementations for prioritizing essential information for display within a vehicle notification system.

A first aspect is a method that includes detecting a change in a traffic scene, wherein the traffic scene encompasses a portion of a vehicle transportation network, in response to detecting the change in the traffic scene, determining that the traffic scene requires more than a defined level of operator engagement, in response to determining that the traffic scene requires more than the defined level of operator engagement, storing the traffic scene to a traffic scene storage location, and determining that an operator is not aware of the traffic scene, and responsive to determining that the operator is not aware of the traffic scene, using a control system of a vehicle to notify the operator that the traffic scene requires more than the defined level of operator engagement.

A second aspect is an apparatus that includes a processor. The processor is configured to detect a change in a traffic scene, wherein the traffic scene encompasses a portion of a vehicle transportation network, in response to detecting the change in the traffic scene, determine whether the traffic scene requires more than a defined level of operator engagement, in response to determining that the traffic scene requires more than the defined level of operator engagement, store the traffic scene to a traffic scene storage location, and determine whether an operator is aware of the traffic scene, and responsive to determining that the operator is not aware of the traffic scene, use a control system of a vehicle to notify the operator that the traffic scene requires more than the defined level of operator engagement.

A third aspect is a non-transitory computer-readable medium storing instructions operable to cause one or more processors to perform operations that include detecting a change in a traffic scene, wherein the traffic scene encompasses a portion of a vehicle transportation network, in response to detecting a change in the traffic scene, determining whether the traffic scene requires more than a defined level of operator engagement, in response to determining that the traffic scene requires more than the defined level of operator engagement, storing the traffic scene to a traffic scene storage location, and determining whether an operator is aware of the traffic scene, and responsive to determining that the operator is not aware of the traffic scene, using a control system of a vehicle to notify the operator that the traffic scene requires more than the defined level of operator engagement.

These and other aspects of the present disclosure are disclosed in the following detailed description of the embodiments, the appended claims, and the accompanying figures.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a diagram of a system for essential information prioritization according to an implementation of this disclosure.

FIG. 4 is a detailed diagram of the components of the vehicle for essential information prioritization according to FIG. 3.

FIG. 5 is a detailed diagram of the components of the server and other vehicles for essential information prioritization according to FIG. 3.

FIG. 6 is a flowchart of an example of a process for prioritizing essential information as an input to a control system of a vehicle.

### DETAILED DESCRIPTION

A vehicle may traverse a portion of a vehicle transportation network. The vehicle transportation network can include one or more unnavigable areas, such as a building; one or more partially navigable areas, such as a parking area (e.g., a parking lot, a parking space, etc.); one or more navigable areas, such as roads (which include lanes, medians, intersections, etc.); or a combination thereof.

The vehicle may include one or more sensors. Traversing the vehicle transportation network may include the sensors generating or capturing sensor data, such as data corresponding to an operational environment of the vehicle, or a portion thereof. For example, the sensor data may include information corresponding to one or more potential hazards that materialize into or are identified as (e.g., resolve to) respective external objects. Such an object may also be referred to as a hazard object herein. Furthermore, the data may be combined with map and location data to create a traffic scene. The traffic scene may include information corresponding to a portion of the vehicle transportation network, hazards object, or other external objects.

When operating a vehicle either remotely or manually, an operator or driver may sometimes encounter situations that the operator does not understand immediately. As each operator may respond to each situation differently, giving each operator as much information as possible may be desirable. The data corresponding to a traffic scene can be used to notify an operator of these situations or potential hazards in which caution may be desired. However, with many notification icons, sounds, or both happening at the same time, an operator may become overwhelmed, annoyed, surprised, etc. The operator may not know how to immediately respond to the situation and become overwhelmed or stressed. Alternatively, the operator may already be aware of the situation and become annoyed. Additionally, when many notifications are displayed, more important notifications may be hidden or ignored due to the number of less important notifications. This may lead to important information being unnoticed and/or ignored by the operator.

Instead, and according to the teachings herein, a notification system that prioritizes essential information for display to an operator is desirable to reduce the number of hidden or ignored notifications and increase the number of important notifications to the operator. Additionally, the notification system may be able to filter (i.e., exclude, limit) the number of notifications based on the operator state and a history of the operator with the type of situations encountered.

This solution can leverage the fact that even when a driving environment is dynamic, the information displayed to an operator can be controlled to prevent overwhelming or annoying an operator. The information displayed can be prioritized according to the dynamic situation (i.e., traffic scene) as well as the needs and capabilities of the operator. As such, operators that tend to be more distracted or stressed may desire a different degree of information displayed than operators that are more focused and alert.

To describe some implementations of the prioritization according to the teachings herein in greater detail, reference is first made to the environment in which this disclosure may be implemented.

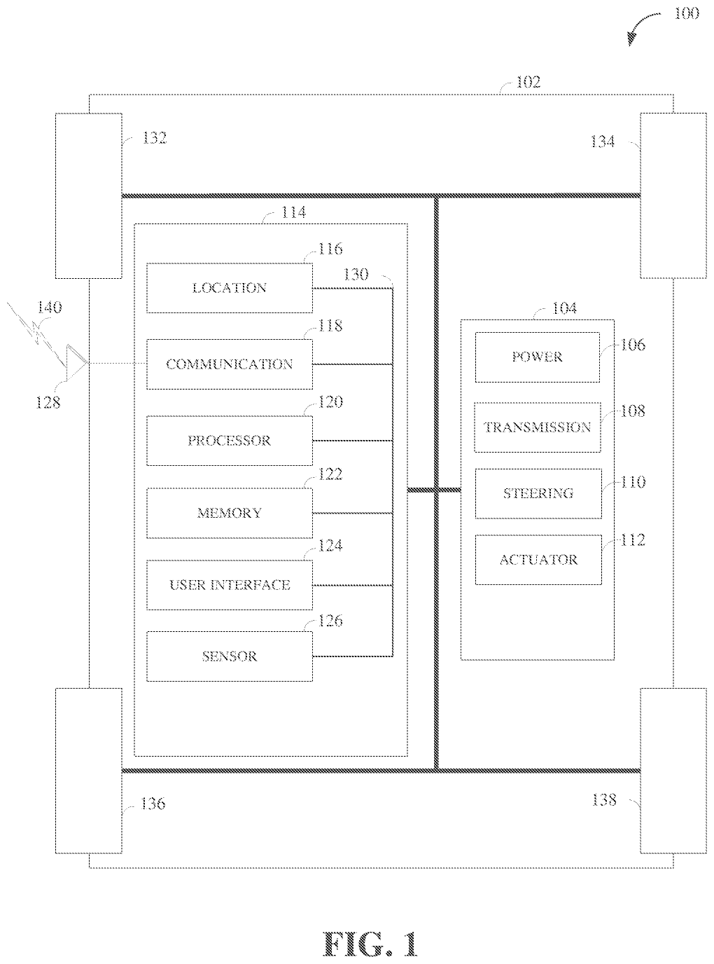

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals; power, such as electrical power or torque; or both information and power may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and is operative to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices. The processor 120 may also implement some or all of the proactive risk mitigation described herein.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), IEEE 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

The vehicle, such as the vehicle 100, may be an autonomous vehicle or a semi-autonomous vehicle. For example, as used herein, an autonomous vehicle as used herein should be understood to encompass a vehicle that includes an advanced operator assist system (ADAS). An ADAS can automate, adapt, and/or enhance vehicle systems for safety and better driving such as by circumventing or otherwise correcting operator errors.

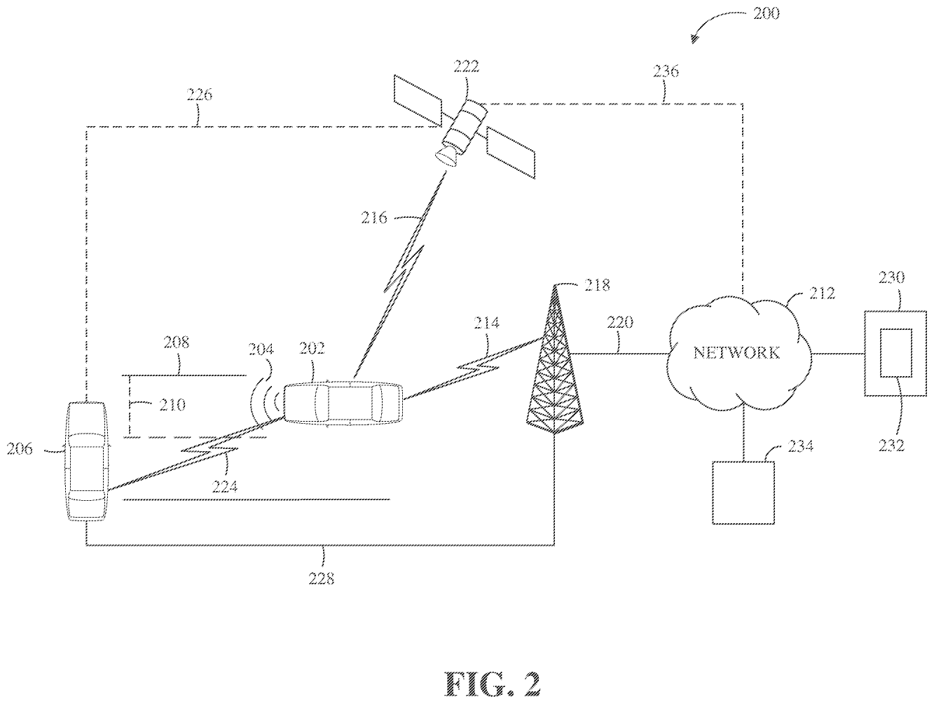

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 226/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

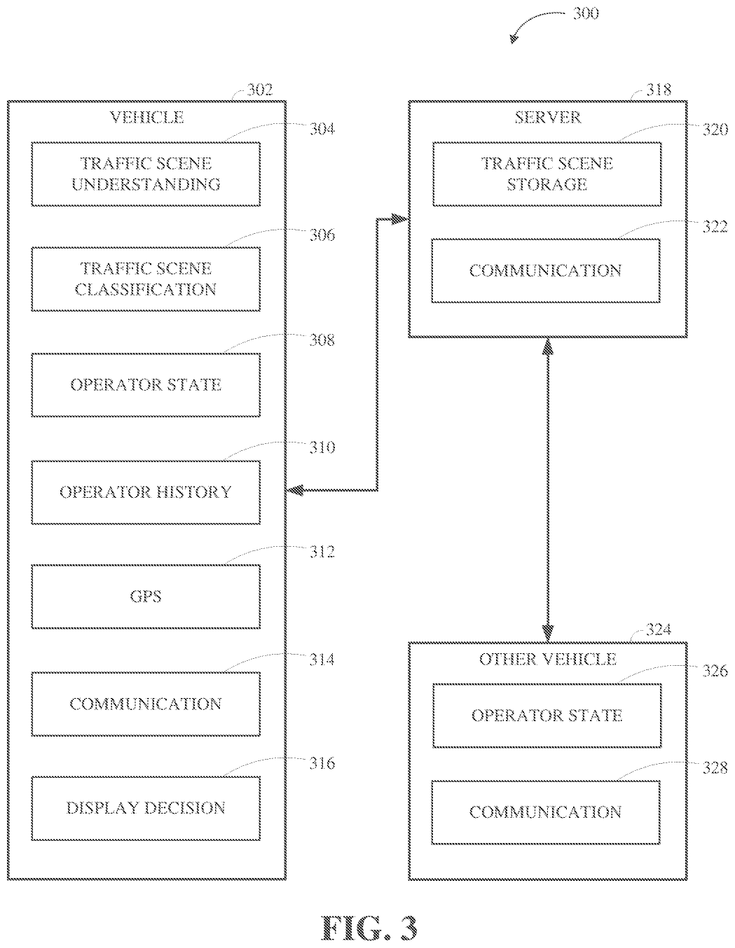

FIG. 3 is a diagram of a system 300 for essential information prioritization according to implementations of this disclosure. Although described with a vehicle traveling through a vehicle transportation network, such as the vehicle transportation network 208, the teachings herein may be used in any area navigable by a vehicle, which areas are collectively referred to as a vehicle transportation network. The system 300 includes a vehicle 302, a server 318, and another vehicle 324. Other examples of the system 300 can include more, fewer, or other components.

The vehicle 302 includes a traffic scene understanding module 304, a traffic scene classification module 306, an operator state module 308, an operator history module 310, a global positioning system (GPS) module 312, a communication module 314, and a display decision module 316. The vehicle 302 maybe the same as or similar to the vehicle 100 of FIG. 1 or the vehicle 202 of FIG. 2. Accordingly, the components of the vehicle 302 may be implemented in whole or in part by components of the vehicle 100, 202 as described in more detail below. In some examples, the components can be combined; in other examples, a component can be divided into more than one component. The components of the vehicle 302 are not required to be implemented in a vehicle, instead at least some of the components may be implemented by a remote support control system, such as a remote support control system operated at the server computing device 234.

The traffic scene understanding module 304 receives sensor data, such as from the sensor 126 from FIG. 1, and determines (e.g., converts to, detects, etc.) objects from the sensor data. That is the traffic scene understanding module 304 determines a current traffic scene (i.e., the out-cabin traffic situation). The traffic scene understanding module 304 may keep track of the current traffic scene. For example, the traffic scene understanding module 304 may receive sensor information indicating that the vehicle 302 is approaching an intersection. Additionally, the sensor information may indicate that there is a traffic accident at the intersection. Alternatively, the sensor information may indicate that construction work is being performed at the intersection that may cause the closure of one or more lanes through the intersection.

The traffic scene understanding module 304 may continuously monitor, in a periodic manner, what type of traffic scene the vehicle 302 may be approaching. The period can be a fixed period (i.e., that has a fixed time interval) or a variable period (i.e., that has a non-fixed time interval). Additionally, the traffic scene understanding module 304 may detect when the current traffic scene changes.

The traffic scene classification module 306, given a traffic scene, determines the level of operator engagement desired to safely navigate the traffic scene. For example, given a traffic scene of crossing an intersection during a power failure in which a traffic signal is not functioning, the traffic scene classification module 306 may determine that the level of operator engagement desired to safely navigate the traffic scene is higher than if the traffic signal was functioning properly.

The operator state module 308 receives sensor data, such as from the sensor 126 from FIG. 1, and determines a current state of the operator. That is the operator state module determines the current level of engagement of the operator. For example, the operator state module 308 may receive an image or stream of image from a camera within the cabin of the vehicle. The image or stream of images from the camera may be used to determine that the operator is facing forward and paying attention to the road. As such, the level of operator engagement may be determined to be relatively high. Alternatively, the image or stream of images from the camera may be used to determine that the operator is looking toward the passenger seat of the vehicle 302 or looking down. As such the level of operator engagement may be determined to be relatively low.

The traffic scene understanding module 304, the traffic scene classification module 306, and the operator state module 308 may be implemented by a controller or processor of the vehicle 302 and/or of the server computing device 234. For example, these components may be implemented by the processor 120 described with regards to FIG. 1.

The operator history module 310 stores an operator state associated with a traffic scene or a type of traffic scene. The operator history module 310 may receive the operator state from the operator state module 308. For example, a traffic scene including a reduction from three lanes to one lane due to road construction may be detected. The operator state module 308 may determine that the operator is experiencing distress due to the current traffic scene based on, for example, a change in monitored behavior such as increasing movements to opposing sides of the seat. The operator history module 310 may store the operator state associated with this type of traffic scene in addition to the current traffic scene. Additionally, or alternatively, the operator history module 310 may retrieve a stored operator state associated with a type of traffic scene or the current traffic scene. In an example, as the vehicle 302 approaches an intersection with a four-way stop, the operator history module 308 may retrieve an operator state associated with the type of traffic scene (i.e., a four-way stop). The operator history module 310 may comprise storage of the vehicle 302, such as memory 122 described previously. In some implementations, the operator history module 310 and/or its data may be located at a server, such as the server 318. When, for example, information for an operator is not determined or otherwise available, data from another operator may initially be used.

The GPS module 312 may be used to obtain the position of the vehicle 302 within the vehicle transportation network. The GPS module 312 may periodically send (e.g., for a fixed or variable period), to the traffic scene classification module 306, the position of the vehicle 302. The GPS module 312 may be referred to as a sensor of the vehicle 302, such as the sensor 126 of the vehicle 100.

The communication module 314 may be used to facilitate communication between the vehicle 302 and the server 318, discussed in more detail below. The communication module 314 may send, receive, or both send and receive data to and from the server 318. The data may include but is not limited to GPS data, traffic scene data, operator state data, or the like. In some implementations, the communication module 314 is similar to the electronic communication unit 118.

The display decision module 316 receives the current traffic scene, the operator state, and the operator history. The display decision module 316 uses the received traffic scene, operator state, and operator history to determine whether to display a notification to the operator. The display can be a head-up display or a screen. For example, the display can form part of a user interface, such as the user interface 124. Examples of notifications are described below.

The server 318 may be implemented by a remote support control system, such as a remote support control system operated at the server computing device 234. As shown in the example of FIG. 3, the server 318 includes a traffic scene storage module 320 and a communication module 322.

The traffic scene storage module 320 of the server 318 is used to store (i.e., save, record, retain) traffic scenes that necessitate more than a predefined level of operator engagement (i.e., burdensome). That is, when the vehicle 302 determines that the traffic scene is burdensome (i.e., stressful, surprising, overwhelming, threatening, dangerous, etc.), the vehicle 302 may send the traffic scene to the server 318 to be stored by the traffic scene storage module 320.

The communication module 322 of the server 318 is used to facilitate communication of data between the server 318 and the vehicle 302, the server 318, and other road users, such as the other vehicle 324 described below, or both. The data may include but is not limited to GPS data, traffic scene data, operator state data, or the like.

The other vehicle 324 may be the same as or similar to the external object 206 or the vehicle 202 of FIG. 2. The other vehicle 324 includes an operator state module 326 and a communication module 328.

The operator state module 326 of the other vehicle 324 receives sensor data, such as from the sensor 126 from FIG. 1, and determines a current state of an operator of the other vehicle. The operator state module 326 may be the same as or similar to the operator state module 308. As such, the operator state module 326 may have all features as described above in reference to the operator state module 308.

The communication module 328 of the other vehicle 324 is used to facilitate communication of data between the other vehicle 324 and the server 318. The data may include but is not limited to GPS data, traffic scene data, operator state data, or the like. The communication module 328 may be the same as or similar to the communication module 314.

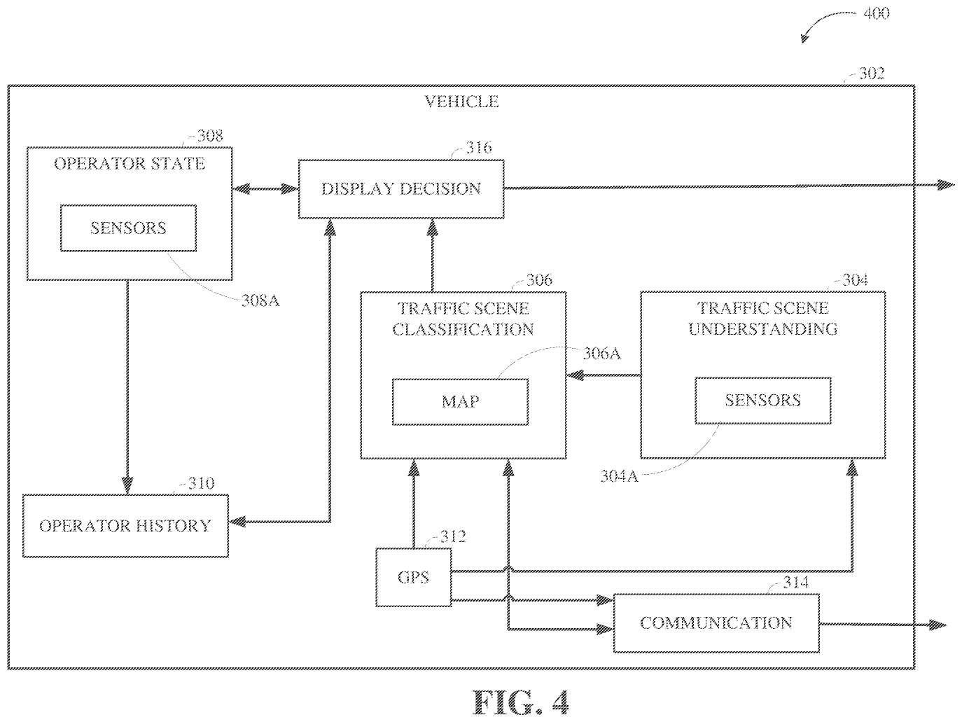

FIG. 4 is a detailed diagram of the components of the vehicle 302 for essential information prioritization according to the example of FIG. 3. The components may be coupled by a bus, such as the bus 130. The traffic scene understanding module 304 receives information from sensors 304A. The traffic scene understanding module 304 may use the data from the sensors 304A to determine the current traffic scene. For example, and as described above, the sensors 304A may include one or more sensors 124 as described with regards to FIG. 1. More specifically, the sensors 304A may include a light detection and ranging (LiDAR) device. The traffic scene understanding module 304 may use the point cloud returned from the LiDAR device combined with map point data to determine a current traffic scene. The traffic scene understanding module 304 may then send (i.e., transmit, communicate) the current traffic scene to the traffic scene classification module 306.

The traffic scene classification module 306 receives a current traffic scene and/or GPS coordinates and determines the level of operator engagement desired to safely navigate the traffic scene. The traffic scene classification module 306 can includes or retrieve data from a map module 306A. The map module 306A may be used to determine a portion of the vehicle transportation network corresponding to the current traffic scene. The traffic scene classification module 306 may classify (i.e., determine a type for) the current traffic scene including whether the current traffic scene is burdensome. The traffic scene classification module 306 may itself determine a level of operator engagement that the traffic scene necessitates or may retrieve this information accessing a traffic scene storage module like the traffic scene storage module 320 of the server 318.

Additionally, the traffic scene classification module 306 may send the current traffic scene to the display decision module 316, the communication module 314, or both. The traffic scene classification module 306 may send the current traffic scene to the communication module 314 to send the current traffic scene to the server 318 of FIG. 3. For example, the traffic scene classification module 306 may determine that the current traffic scene is burdensome. In this case, the traffic scene classification module 306 may send the current traffic scene to the server 318 for storage (i.e., saving, recording, retaining) or for further analysis. Furthermore, the current traffic scene may need to be retrieved at a later time or require further analysis. Accordingly, the server 318 may store the traffic scene classification (e.g., in the traffic scene storage module 320) of the current traffic scene.

Furthermore, the traffic scene classification module 306 may send the current traffic scene to the display decision module 316 after classifying the current traffic scene as burdensome. For example, the current traffic scene may indicate that there is an accident ahead on the road. The traffic scene classification module 306 may determine that an accident on the road is burdensome (i.e., requiring more than a predefined level of operator engagement) and classify the current traffic scene as such. The traffic scene classification module 306 may send the current traffic scene to the display decision module 316 to decide whether and how to notify the operator.

The display decision module 316 receives the current traffic scene and classification from the traffic scene classification module 306. The display decision module 316 may determine whether a notification is displayed to the operator as essential information. In other words, the display decision module 316 prioritizes essential information for display to the operator through a notification system of the vehicle. The display decision module 316 may request operator state data from the operator state module 308. Additionally, the display decision module 316 may request operator history data from the operator history module 310. For example, the display decision module 316 may receive a traffic scene classified as burdensome; however, to determine whether to notify the operator, the display decision module 316 may evaluate the state of the operator and the history of the operator given the type of traffic scene.

The operator state module 308 receives data from sensors 308A to determine the current state of the operator (i.e., operator state). The sensors 308A may be a sensor such as the sensor 124 described in with regards to FIG. 1. For example, the sensors 308A may include a camera, a heartrate monitor, a microphone, a button, etc. A camera mounted inside the cabin of the vehicle 302 may capture an image or a stream of images of the operator. In another example, a microphone mounted within the cabin of the vehicle 302 may capture audio within the cabin of the vehicle 302 from the operator. In a further example, a heartrate monitor mounted within the vehicle, such as within the steering wheel of the vehicle 302, or an external heartrate monitor worn by the operator, may be linked to the vehicle 302. In each case, the sensor data may be used individually or in combination to determine the current state of the operator.

The operator history module 310 stores (i.e., saves, retains, records) operator state data associated with a traffic scene or a traffic scene type (e.g., four-way stop, signaled intersection, accident, construction, non-functioning traffic signal, etc.). The combined operator state data and traffic scene or traffic scene type may be thought of as an operator history record. Upon request, the operator history module 310 may retrieve a previously stored operator history record or store a new operator history record. The operator history information may be used by the display decision module 316 to help determine whether and how to notify the operator of the current traffic scene. For example, the display decision module 316 may receive a traffic scene classified as burdensome; however, the operator history module 310 retains a record associated with the current traffic scene and, together with the operator state, the display decision module 316 may determine that the operator has already been notified of the current traffic scene. Alternatively, the operator history module 310 may not find a record associated with the current traffic scene so that the display decision module 316 may determine that the operator has not been notified of the current traffic scene.

The GPS module 312 may send the location of the vehicle 302 to the traffic classification module 306 and the communication module 314. The traffic classification module 306, upon receiving the location from GPS module 312, may look up the location of the vehicle 302 with the map module 306A to determine if the location corresponds to a known burdensome traffic scene. Additionally, the communication module 314 may transmit the location to the server 318 of FIG. 3 to determine if the location corresponds to a known burdensome traffic scene.

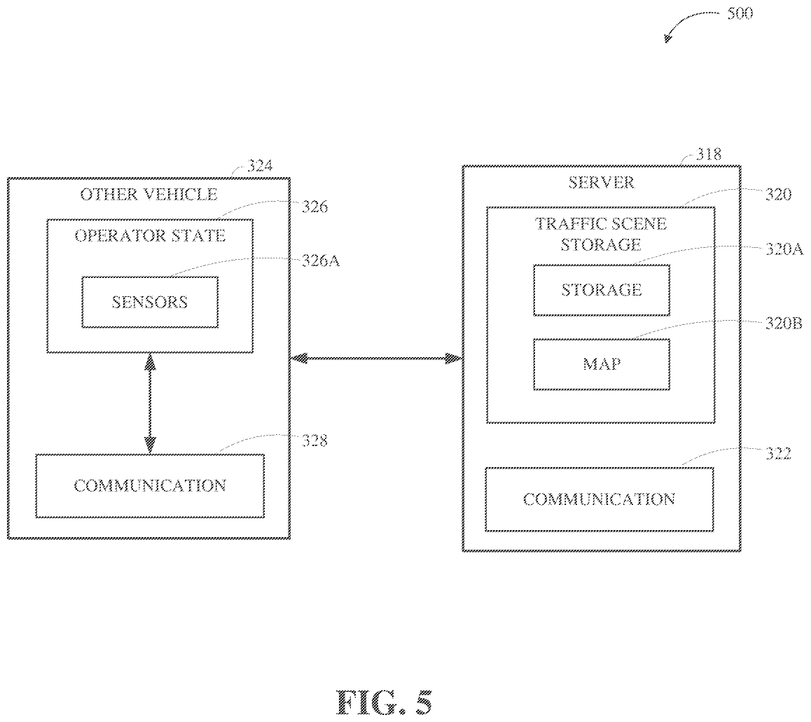

FIG. 5 is a detailed diagram of the components of the server 318 and other vehicles, such as the other vehicle 324, for essential information prioritization according to FIG. 3.

In the server 318, the traffic scene storage module 320 stores traffic scene data in storage 320A, such as a memory. The traffic scene data may include location information (i.e., GPS coordinates), traffic scene type data, and traffic scene classifications, in addition to other data. The storage 320A may be implemented using a relational database, object database, flat files, or the like. The map 320B may represent a portion of the vehicle transportation network, such as the vehicle transportation network 208. The traffic scene storage module 320 may retrieve or store traffic scene data upon request. The request for traffic scene data may be received by the communication module 322. The communication module may be similar to the communication module 314 of FIG. 4. For example, the vehicle 302 may determine, via the traffic scene classification module 306, that the current traffic scene is burdensome. As such the vehicle 302 may send the current traffic scene and corresponding GPS data, traffic scene type, and traffic scene classification (i.e., traffic scene data) to the server 318. The communication module 314 may send the traffic scene data to the server 318 via the communication module 322.

The other vehicle 324, as described above, includes an operator state module 326 that, as described above, can be similar to the operator state module 308. The sensors 326A may be similar to the sensors 308A. The other vehicle 324, traveling through the same portion of the vehicle transportation network may query from the server 318, via the communication module 322, whether the current traffic scene is burdensome. The server 318, having stored the current traffic scene within the storage 320A of the traffic scene storage module 320 may respond with traffic scene data.

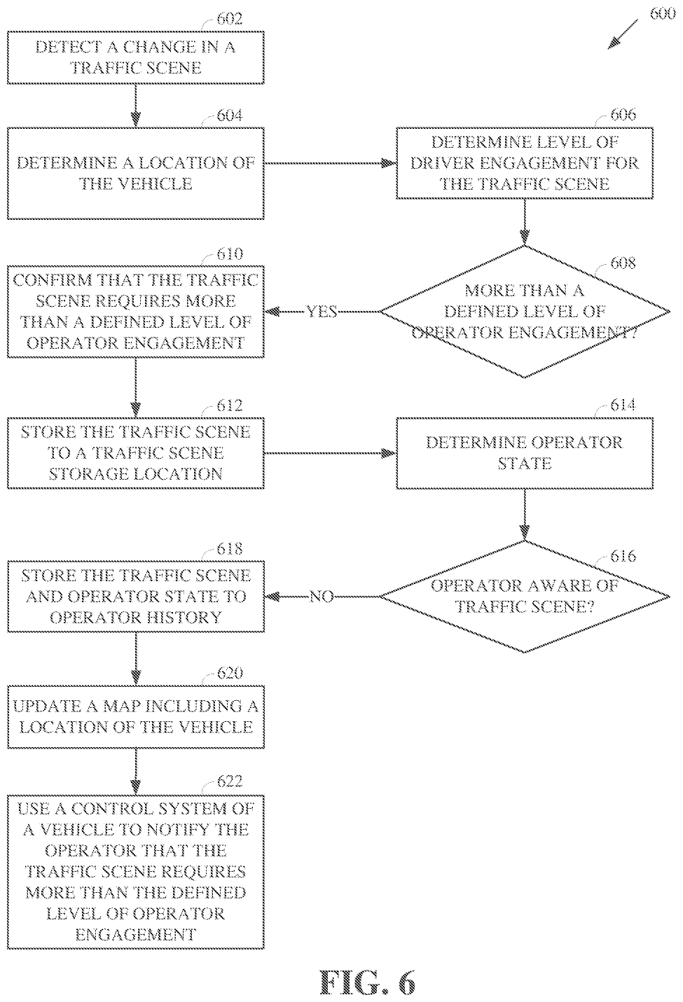

FIG. 6 is a flowchart of an example of a process 600 for prioritizing essential information as an input to a notification system of a vehicle 302. The process 600 includes operations 602 through 622, which are described below. The process 600 can be implemented in whole or in part by the system 300 of FIG. 3, such as by the vehicle 302 and/or the server 318. The process 600 can be stored in a memory (such as the memory 122 of FIG. 1) as instructions that can be executed by a processor (such as the processor 120 of FIG. 1) of a vehicle (such as the vehicle 100 of FIG. 1). The process 600 may be implemented in whole or in part by a remote support control system or an external server, such as at the server computing device 234.

The process 600 receives inputs, where the inputs may include sensor data (i.e., sensor observations), such as measurements from one or more sensors 126. The sensor data can be used to detect a traffic scene. That is, for example, the sensor data can be used to determine where real-world objects are located with a portion of the vehicle transportation network.

In an example, data from one or more cameras can be used to determine the class of a detected object. Non-limiting examples of classes include “car,” “sports car,” “sedan,” “large truck,” “pedestrian,” and “bicycle.” In another example, a classification of a detected object can be assigned based on the motion, over time, of LiDAR data, e.g., a LiDAR point cloud. It is noted that different sensor data may provide different object classifications. For example, a first classification of “bicycle” may be determined based on the LiDAR data whereas a second classification of “jogger” may be determined based on camera data. Accordingly, the classification of an object may be determined probabilistically (e.g., which of the first or second classifications is more likely). As the classification is probabilistic, the classification of an object can change over time. Different sensor data may be fused together to determine the classification. As such, different sensor data may be fused together to determine a traffic scene.

At operation 602, the process 600 detects a change in a traffic scene. The change in the traffic scene may be detected by the traffic scene understanding module 304 of FIG. 4. For example, the change in the traffic scene may be due to a change in the location of the vehicle 302, or the change in the traffic scene may be due to an updated classification of the detected objects within the traffic scene.

At operation 604, the process 600 determines a location for the vehicle. The location may be determined using GPS, such as the GPS module 312 of FIG. 4. The location of the vehicle may be used by the traffic scene classification module 306 of FIG. 4 to determine a portion the vehicle transportation network, using the map module 306A.

At operation 606, the process 600 determines a level of operator engagement for the traffic scene. The operation 606 may be performed by the traffic scene classification module 306 of FIG. 4. The operation 606 may receive the traffic scene and the location of the vehicle as inputs. For example, the operation 606 may receive a traffic scene indicating that an accident has occurred at an intersection as well as a location of the vehicle indicating that the vehicle is approaching the intersection. The process 600 may use the location of the vehicle to check if the map module 306A of FIG. 4 indicates a level of operator engagement for the traffic scene corresponding to the location of the vehicle. The map module 306A may indicate that the traffic scene has a known level of operator engagement. As such, the traffic scene may be assigned the level of operator engagement indicated by the map module 306A. Alternatively, the map module 306A may indicate that the traffic scene does not have a known level of operator engagement. In this case, the traffic scene classification module 306 may analyze the traffics scene to determine a level of operator engagement.

At operation 608, the process 600 determines whether the level of operator engagement for the traffic scene is more than a predefined level of operator engagement. In other words, the process 600 determines if the traffic scene may be burdensome. If the process 600 determines that the traffic scene is not burdensome, the process 600 ends. However, if the process 600 determines that the traffic scene is burdensome, the process continues to operation 610.

The technique by which the process 600 determines whether the level of operator engagement for the traffic scene is more than the predefined level of operator engagement (i.e., burdensome or stressful) is not particularly limited. Some examples of how a traffic scene is analyzed follow.

In some implementations, an internal camera (i.e., a camera internal to the vehicle) can monitor the facial expression or (so-called unique or signature) activities of the operator. Alternatively, or additionally, a microphone can record their utterances. A facial expression, such as an overwhelmed or surprised expression, or a gesture of confusion or frustration can indicate that the level of operator engagement for the traffic scene is more than the predefined level of operator engagement (which can be no expression or a smile, for example). Comments detected by the microphone such as “tired” can be interpreted as the operator being burden/stressful (e.g., as compared to a predefined level of operator engagement of no utterance or normal conversation.

In some implementations, one or more bio sensors such as a galvanic skin response (GSR) sensor may be used to measure an elevated stress level as compared to a predefined stress level that identifies a predefined level of operator engagement.

In some implementations, the number of other vehicles/vulnerable road users within a defined distance can be used to evaluate the burden by, for example, comparing the number to a defined number of vehicles/vulnerable road user that corresponds to the predefined stress level. When the number exceeds the defined number, the level of operator engagement for the traffic scene is more than the predefined level of operator engagement at operation 608. Information regarding the number within the defined distance can be obtained by detection using a short-range LIDAR scanner, an external camera, or the like.

In some implementations, the predefined level of operator engagement may be linked to whether the traffic scene is a rare (unusual, infrequently seen, etc.) traffic scene. Traffic scenes having sharp angled intersection (e.g., having an angle between two adjacent streets below a predefined angle), an intersection whose distance from the previous intersection is short (e.g., having a distance below a predefined distance), an intersection whose number of lanes more than 4, and the like, may be determined as a condition where the level of operator engagement for the traffic scene is more than the predefined level of operator engagement.

In some implementations, an estimated or measured time to exit from a specific traffic scene can also be used to estimate whether the traffic scene is burdensome at operation 608. For example, the time can be compared to the average time obtained from statistical analysis of the other driver data on the server related to the traffic scene. For example, the other driver data forms the predefined level of operator engagement against which a current time to exit (i.e., the level of operator engagement) is compared at operation 608.

The above examples describe mostly deterministic techniques that can be used to perform operation 608. However, a machine-learning model can be trained to make the determination at operation 608 using data such as the above data-facial expressions, signature activities, bio measures values, the number of cars (or other visual noise), etc.

At operation 610, the process 600 optionally confirms that that traffic scene requires more than a predefined level of operator engagement. The confirmation that the traffic scene requires more than a predefined level of operator engagement may be performed by the traffic scene classification module 306 of FIG. 4 in conjunction with the server 318 and the traffic scene storage module 320 of FIG. 5. For example, the traffic scene classification module 306 may determine that the traffic scene is burdensome based on the level of operator engagement corresponding to the location of the vehicle using the map module 306A. However, the traffic scene classification module 306 may send the traffic scene and location of the vehicle (i.e., confirmation request), via the communication module 314 of FIG. 4 to the server 318 for confirmation. The server 318 may receive the traffic scene and the location of the vehicle and via the traffic scene storage module 320 determine that the level of operator engagement has changed (i.e., been updated, been removed, been cleared). As such the traffic scene is no longer considered burdensome. The server 318 may send a confirmation response (acknowledgement) back to the traffic scene classification module 306 including the result of the confirmation request.

In another example, the traffic classification module 306 may determine that the level of operator engagement for the traffic scene is burdensome based on an analysis of the traffic scene due to the map module 306A not having a level of operator engagement corresponding to the traffic scene and the location of the vehicle. In this case, the traffic classification module 306 may send the traffic scene and the location of the vehicle to the server 318, via the communication module 314, for confirmation. The server 318 may retrieve a corresponding level of operator engagement for the traffic scene and corresponding location indicating that the traffic scene is not burdensome; however, the level of operator engagement stored by the traffic scene storage module 320 is out of date (i.e., old, stale, not relevant). As such, the process 600 continues to operation 612 and stores the traffic scene to a traffic scene storage location such as the traffic scene storage module 320 of FIG. 4. The traffic scene storage location may be used by the server 318 of FIG. 4 to respond to confirmation request from the vehicle 302 or another road user, such as the other vehicle 324. The traffic scene storage location may store traffic scene data associated with a corresponding level of operator engagement and a location.

At operation 614, the process 600 determines an operator state. The operator state (i.e., stressed, distracted, focused, etc.) may be determined by the operator state module 308 of FIG. 4. The drive state may be determined based on current factors of the operator using sensors such as the sensors 308A of FIG. 4. For example, one sensor may be a camera mounted within the cabin of the vehicle. The process 614 may use an image or stream of images from the camera to determine that the operator is looking forward, eyes on the road, and focused. Alternatively, the process 614 may use an image or stream of images to determine that the operator is looking down, holding a cellphone, or is otherwise distracted.

At operation 616, the process 600 determines if the operator is aware of the traffic scene. That is the process 600 may use the operator state, the operator history, and the traffic scene to determine if the operator is aware of the traffic scene. For example, the operation 612 may determine that the operator state is distracted, such that there is a high probability that the operator is not aware of the current traffic scene. Additionally, the process 600 may use the operator history module 310 of FIG. 4 to determine if the operator was previously notified about the traffic scene. Where the operator state is distracted, the traffic scene is burdensome, and the operator was not previously aware of the traffic scene, then the process 600 may determine that the operator is not aware of the traffic scene.

In another example, the operation 612 may determine that the operator state is distracted, and the traffic scene may be burdensome. However, the operator history may indicate that the operator was previously notified that about the traffic scene. The operation 612 may evaluate the number of times that the operator was previously notified about the traffic scene. The operator history module 310 of FIG. 4 may store multiple operator history records associated with each traffic scene or traffic scene type. The operation may determine that the operator was already notified multiple times about the traffic scene as such the operator may be aware of the traffic scene. In either case, if the operator is aware of the traffic scene, the process 600 ends. Otherwise, the process 600 advances to operation 618.

At operation 618, the process 600 may store the traffic scene and the operator state to the operator history. The operation 618 may be performed by the operator history module 310 of FIG. 4. The traffic scene and the operator state may be stored together along with a traffic scene type such that the operator history may be retrieved based on a specific traffic scene or a type of traffic scene. For example, the operation 618 may receive, as input, a traffic scene of an accident at an intersection, with a traffic scene type of accident and an operator state of stressed. The traffic scene, traffic scene type, and operator state may be stored together such when future reference to the specific traffic scene is made, the process 600 may be able to determine the operator state associated with the traffic scene at that time and compare the stored traffic scene with a current traffic scene. Additionally, the process 600 may retrieve the operator state based on a traffic scene type. In this case, there may be more than one record associated with the traffic scene type and multiple determinations of the operator state. The process 600 may be able to determine (i.e., predict) a likely operator state based on the past associated operator state with the type of traffic scene.

At operation 620, the process 600 updates a map including a location of the vehicle within the vehicle transportation network, such as a map determined by the map module 306A of FIG. 4. The map may be updated by the traffic scene classification module 306 of FIG. 4. The map may be updated to account for the traffic scene. For example, the map may not have an associated traffic scene, or the map may have an outdated traffic scene associated with the location of the vehicle. As such, to improve detection of burdensome traffic scenes for future use, the process 600 may update the map with the data associated with the traffic scene. For example, given that the map did not contain an associated traffic scene for a given location, the map may store the traffic scene so that on subsequent checks on the traffic scene the map will be able to retrieve a classification of the traffic scene.

Operation 620 can also include prioritizing essential information as the input to a notification system of a vehicle, such as the notification described below with regards to operation 622. What information is prioritized over other information for generating notification(s) and possibly taking other action(s) can be ascertained deterministically, using trained machine-learning models, or a combination of these techniques.

A general prioritization order for each traffic object may be defined. The order can be modified based on specified conditions. For example, simple logic such as defining a prioritization value and adding values based on the real-time situation may be used to determine the priority of information. The order can be modified by a condition such as the distance to each traffic object. The prioritization value for a specific traffic object can be decreased when it is concluded that the operator is already aware of the object.

At operation 622, the process 620 uses a control system of the vehicle to notify the operator that the traffic scene requires more than a predefined level of operator engagement. In other words, the vehicle displays a notification to the operator that the traffic scene is burdensome and optionally what prioritized essential information is makes the traffic scene require more than the predefined level of operator engagement. Alternatively, the vehicle may notify that operator that caution may be desired. The notification may be a notification that an automated action has been taken responsive to determining that the traffic scene requires more than the defined level of operator engagement and optionally why based on the prioritized essential information. For example, the notification may include that an Advance Driver Assistance System (ADAS) has been activated and optionally what action has been taken (e.g., braking, steering, etc.).

A couple of examples of prioritizing information are next described that explain the prioritization of operation 620 and the notification at operation 622.

In an example where a vehicle approaches or enters a traffic scene where a trolley track, a bus lane, and a crosswalk later down the block are present in order, the process 600 may conclude that the level of operator engagement for the traffic scene is more than the predefined level of operator engagement. According to an initial prioritization order, the trolley track is most important to prevent an accident initially, the crosswalk later down the block is next most important, and the bus lane is the least important. If there is a sufficient time gap before the vehicle reaches the trolley track, then the trolley track and the bus lane may be treated as one pair, such as using a notification to “keep left”, which prioritizes the trolley track but also addresses the bus lane. Thereafter, the crosswalk may be treated separately, such as by applying the brakes. If all three objects were instead to occur within a defined distance of the vehicle (e.g., based on speed), such within a hundred feet, then the crosswalk may receive priority, reducing the priority of the trolley track in favor of first notifying the operator of the presence of the crosswalk. This example illustrates how a prioritization order can change based on distance.

In another example, a vehicle approaches or enters a traffic scene with a mid-block crosswalk and a point at which a separated bicycle lane merges into the lane in which the vehicle is traveling. If the two are close together, priority can be based on which is closest. For example, a notification of the presence of the first object, with or without automatic braking, may occur without an additional notification of the second, further object under the assumption that in notifying the operator and/or in slowing the operator down for the first object, the operator will be more prepared for the second object. Alternatively, the system may provide a notification regarding the less common object. For example, if the operator has stopped for several crosswalks, there can exist an expectation that they will stop for the next one. The system can prioritize a notification of the change in the bike lane. This example illustrates how the prioritization of a specific traffic object can be decreased if an operator is inferred to already be aware of the object.

The teachings herein describe the importance of prioritizing some information over other information for notifications and control of a vehicle. For example, if the operator is aware of a traffic object that needs an urgent response, such as a vehicle approaching from the right direction when the vehicle is going to turn left from a parking lot to a public road, a notification can force a response or at least consideration of the potential risk. This can delay a response to the traffic object (the vehicle), making such a notification undesirable. Furthermore, if the number of simultaneous notifications is increased due to the presence of other objects within the traffic scene, the attention of the operator can be consumed by these lower priority objects unless notifications are not made or are delayed until the immediate concern is addressed.

Herein, the terminology “driver” or “operator” may be used interchangeably. As used herein, the terminology “processor”, “computer”, or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
detecting a change in a traffic scene, wherein the traffic scene encompasses a portion of a vehicle transportation network;
in response to detecting the change in the traffic scene, determining that the traffic scene requires more than a defined level of operator engagement;
in response to determining that the traffic scene requires more than the defined level of operator engagement:
storing the traffic scene to a traffic scene storage location; and
determining that an operator is not aware of the traffic scene; and
responsive to determining that the operator is not aware of the traffic scene, using a control system of a vehicle to notify the operator that the traffic scene requires more than the defined level of operator engagement.

2. The method of claim 1, wherein determining whether the operator is aware of the traffic scene is based on a state of the operator and an operator history.

3. The method of claim 2, comprising:
storing the traffic scene and the state of the operator in the operator history.

4. The method of claim 3, wherein the state of the operator is at least one of surprised or overwhelmed.

5. The method of claim 1, comprising:
transmitting a confirmation request to an external server to confirm that the traffic scene requires more than the defined level of operator engagement;
receiving a confirmation response from the external server; and
in response to receiving the confirmation response confirming that the traffic scene requires more than the defined level of operator engagement, saving a location of the traffic scene to a map of the vehicle.

6. The method of claim 1, comprising:
determining, using a global positioning system of the vehicle, a location of the vehicle, wherein the traffic scene corresponds to the location of the vehicle.

7. The method of claim 6, comprising:
updating a map of the vehicle based on the location of the vehicle and the traffic scene storage location.

8. An apparatus, comprising:
a memory; and
a processor configured to execute instructions stored in the memory to:
detect a change in a traffic scene, wherein the traffic scene encompasses a portion of a vehicle transportation network;
in response to detecting a change in the traffic scene, determine whether the traffic scene requires more than a defined level of operator engagement;
in response to determining that the traffic scene requires more than the defined level of operator engagement:
store the traffic scene to a traffic scene storage location; and
determine whether an operator is aware of the traffic scene; and
responsive to determining that the operator is not aware of the traffic scene, use a control system of a vehicle to notify the operator that the traffic scene requires more than the defined level of operator engagement.

9. The apparatus of claim 8, wherein determining whether the operator is aware of the traffic scene is based on a state of the operator and an operator history.

10. The apparatus of claim 9, wherein the instructions comprise instructions to:
store the traffic scene and the state of the operator in the operator history.

11. The apparatus of claim 10, wherein the state of the operator is at least one of surprised or overwhelmed.

12. The apparatus of claim 8, wherein the instructions comprise instructions to:
transmit a confirmation request to an external server to confirm that the traffic scene requires more than the defined level of operator engagement;
receive a confirmation response from the external server; and
in response to receiving the confirmation response confirming that the traffic scene requires more than the defined level of operator engagement, save a location of the traffic scene to a map of the vehicle.

13. The apparatus of claim 8, wherein the instructions comprise instructions to:
determine, using a global positioning system of the vehicle, a location of the vehicle, wherein the traffic scene corresponds to the location of the vehicle.

14. The apparatus of claim 13, wherein the instructions comprise instructions to:
update a map of the vehicle based on the location of the vehicle and the traffic scene storage location.

15. A non-transitory computer-readable medium storing instructions operable to cause one or more processors to perform operations comprising:
detecting a change in a traffic scene, wherein the traffic scene encompasses a portion of a vehicle transportation network;
in response to detecting a change in the traffic scene, determining whether the traffic scene requires more than a defined level of operator engagement;
in response to determining that the traffic scene requires more than the defined level of operator engagement:
storing the traffic scene to a traffic scene storage location; and
determining whether an operator is aware of the traffic scene; and
responsive to determining that the operator is not aware of the traffic scene, using a control system of a vehicle to notify the operator that the traffic scene requires more than the defined level of operator engagement.

16. The non-transitory computer-readable medium of claim 15, wherein determining whether the operator is aware of the traffic scene is based on a state of the operator and an operator history.

17. The non-transitory computer-readable medium of claim 16, wherein the operations further comprise:
storing the traffic scene and the state of the operator in the operator history.

18. The non-transitory computer-readable medium of claim 17, wherein the state of the operator is at least one of surprised or overwhelmed.

19. The non-transitory computer-readable medium of claim 15, wherein the operations further comprise:
transmitting a confirmation request to an external server to confirm that the traffic scene requires more than the defined level of operator engagement;
receiving a confirmation response from the external server; and
in response to receiving the confirmation response confirming that the traffic scene requires more than the defined level of operator engagement, saving a location of the traffic scene to a map of the vehicle.

20. The non-transitory computer-readable medium of claim 15, wherein the operations further comprise:
determining, using a global positioning system of the vehicle, a location of the vehicle, wherein the traffic scene corresponds to the location of the vehicle; and
updating a map of the vehicle based on the location of the vehicle and the traffic scene storage location.
